(19) United States
(12) Patent Application Publication
(10) Pub. No.: US 2026/0094564 A1
(43) Pub. Date: Apr. 2, 2026

(54) DISPLAY PANEL AND DRIVING METHOD THEREOF, AND DISPLAY APPARATUS

(71) Applicant: TIANMA ADVANCED DISPLAY TECHNOLOGY INSTITUTE (XIAMEN) CO., LTD., Xiamen (CN)

(72) Inventor: Yingteng ZHAI, Xiamen (CN)

(21) Appl. No.: 19/411,661

(22) Filed: Dec. 8, 2025

(30) Foreign Application Priority Data
Jun. 30, 2025 (CN) 202510889993.0

(51) Int. Cl. G09G 3/32

(52) U.S. Cl. CPC G09G 3/32; G09G 2310/08; G09G 2320/0233; G09G 2320/0247; G09G 2320/0633; G09G 2320/064

(57) ABSTRACT

Embodiments of the present disclosure provide a display panel and a driving method thereof, and a display apparatus for improving the brightness control accuracy of sub-pixels at low grayscales. The display panel includes a plurality of sub-pixels. For one sub-pixel, a frame includes at least two sub-frames. The at least two sub-frames includes light-emitting periods during one of which a light-emitting control signal is at an enable level. Within the frame, durations of the light-emitting periods of one sub-pixel are different within the at least two sub-frames.

### CROSS-REFERENCE TO RELATED APPLICATION

The present application claims priority to Chinese Patent Application No. 202510889993.0, filed on Jun. 30, 2025, the content of which is incorporated herein by reference in its entirety.

### TECHNICAL FIELD

The present disclosure relates to the technical field of displaying and, in particular, to a display panel and a driving method thereof, and a display apparatus.

### BACKGROUND

With continuous development of science and technology, more and more display apparatus are widely used in people's daily life and work, and become an indispensable and important tool for people today. Moreover, with the continuous development of display technology, the requirements of consumers for displays have been continuously increased, and various types of displays are emerging endlessly, such as mini light-emitting diode (Mini LED), and micro light-emitting diode (Micro LED).

Currently, the brightness control accuracy of the display panel is relatively low at low grayscales.

### SUMMARY

In an aspect, the present disclosure provides a display panel. The display panel includes a plurality of sub-pixels. For one of the plurality of sub-pixels, a frame includes at least two sub-frames, the at least two sub-frames includes light-emitting periods during one of which a light-emitting control signal is at an enable level. Within the frame, durations of the light-emitting periods of one of the plurality of sub-pixels are different within the at least two sub-frames.

In another aspect, the present disclosure provides a driving method for a display panel. The display panel includes a plurality of sub-pixels. The driving method includes: for one of the plurality of sub-pixels, controlling a frame to include at least two sub-frames. The at least two sub-frames includes light-emitting periods during one of which a light-emitting control signal is at an enable level. Within the frame, durations of the light-emitting periods of one of the plurality of sub-pixels are different within the at least two sub-frames.

In another aspect, the present disclosure provides a display apparatus. The display apparatus includes a display panel. The display panel includes a plurality of sub-pixels. For one of the plurality of sub-pixels, a frame includes at least two sub-frames, the at least two sub-frames includes light-emitting periods during one of which a light-emitting control signal is at an enable level. Within the frame, durations of the light-emitting periods of one of the plurality of sub-pixels are different within the at least two sub-frames.

### BRIEF DESCRIPTION OF DRAWINGS

In order to clearly illustrate the technical solutions of embodiments of the present disclosure, the drawings, which are intended to be used in the description of the embodiments, are briefly described as below. It will be apparent that other drawings described below are merely some embodiments of the present disclosure, and other drawings may be obtained by those skilled in the art according to these drawings.

FIG. 1 is a schematic diagram of an equivalent circuit of a sub-pixel according to some embodiments of the present disclosure;

FIG. 2 is an operation timing diagram of a pixel driving circuit according to some embodiments of the present disclosure;

FIG. 3 is an operation timing diagram of a further pixel driving circuit according to some embodiments of the present disclosure;

FIG. 4 is an operation timing diagram of a further pixel driving circuit according to some embodiments of the present disclosure;

FIG. 5 an operation timing diagram of a further pixel driving circuit according to some embodiments of the present disclosure;

FIG. 6 an operation timing diagram of a further pixel driving circuit according to some embodiments of the present disclosure;

FIG. 7 an operation timing diagram of a further pixel driving circuit according to some embodiments of the present disclosure;

FIG. 8 an operation timing diagram of a further pixel driving circuit according to some embodiments of the present disclosure;

FIG. 9 is a schematic diagram of a display panel according to some embodiments of the present disclosure;

FIG. 10 is a schematic circuit diagram of a driving unit according to some embodiments of the present disclosure;

FIG. 11 is a schematic diagram of signals of a first input signal line according to some embodiments of the present disclosure; and

FIG. 12 is a schematic diagram of a display apparatus according to some embodiments of the present disclosure.

### DESCRIPTION OF EMBODIMENTS

In order to better understand the technical solutions of the present disclosure, embodiments of the present disclosure are described in detail below with reference to the accompanying drawings.

It should be noted that, the described embodiments are merely some but not all of the embodiments of the present disclosure. All other embodiments obtained by a person of ordinary skill in the art based on the embodiments of the present disclosure shall fall within the scope of the present disclosure.

The terms used in the embodiments of the present disclosure are for the purpose of describing specific embodiments only and are not intended to limit the present disclosure. As used in the embodiments and the appended claims of the present disclosure, the singular forms of “a/an”, “the”, and “said” are intended to include plural forms, unless otherwise clearly specified by the context.

It should be understood that the term “and/or” used herein is merely an association relationship describing an associated object and indicates that there may be three relationships. In the present disclosure, A and/or B may indicate: only A, both A and B, and only B. In addition, the symbol “/” in the context generally indicates that the relation between the objects in front and at the back of “/” is an “or” relationship.

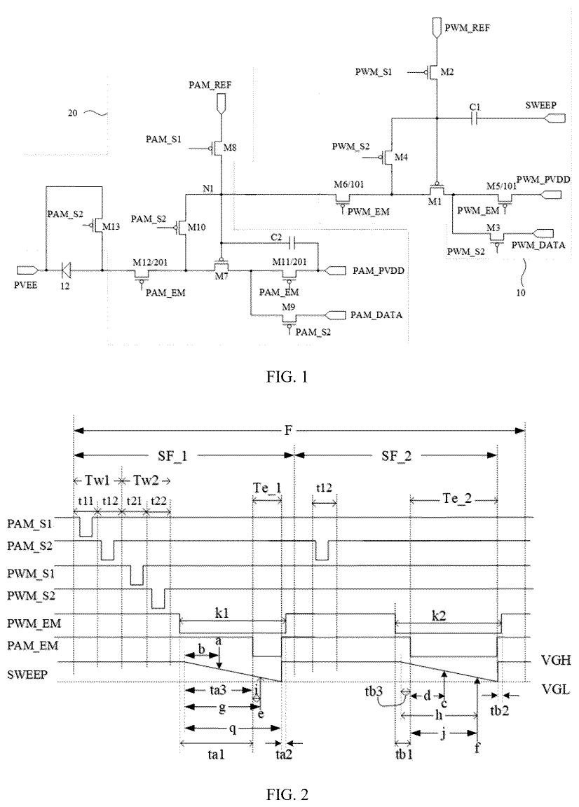

The present disclosure provides a display panel. The display panel includes a plurality of sub-pixels. FIG. 1 is a schematic diagram of an equivalent circuit of a sub-pixel according to some embodiments of the present disclosure. In some embodiments of the present disclosure, as shown in FIG. 1, the sub-pixel 1 includes a pixel driving circuit 11 and a light-emitting element 12 electrically connected to each other. The pixel driving circuit 11 includes a pulse width modulation (PWM) module 10 and a pulse amplitude modulation (PAM) module 20 electrically connected to each other. The pulse amplitude modulation module 20 is electrically connected to the light-emitting element 12.

The pulse amplitude modulation module 20 is configured to control an amplitude of a driving current based on an applied amplitude data voltage PAM_DATA. The pulse width modulation module 10 is configured to control a pulse width of the driving current. In some embodiments of the present disclosure, the pulse width modulation module 10 is configured to control the pulse width of the driving current flowing through the light-emitting element 12 based on a sweep driving signal SWEEP and a pulse width data voltage PWM_DATA.

In some embodiments of the present disclosure, as shown in FIG. 1, the pulse amplitude modulation module 20 includes a first light-emitting control unit 201, which turns on in response to an amplitude light-emitting control signal PAM_EM being at an enable level. As shown in FIG. 1, the pulse amplitude modulation module 20 includes a third light-emitting control transistor M11 and a fourth light-emitting control transistor M12.

The pulse width modulation module 10 includes a second light-emitting control unit 101, which turns on in response to a pulse width light-emitting control signal PWM_EM being at an enable level. As shown in FIG. 2, the second light-emitting control unit 101 includes a first light-emitting control transistor M6 and a second light-emitting control transistor M5.

As shown in FIG. 1, the pulse width modulation module 10 further includes a first drive transistor M1, a first gate reset transistor M2, a first data writing transistor M3, a first compensation transistor M4 and a first capacitor C1.

The second light-emitting control transistor M5 is connected between a second power signal line PWM_PVDD and a first electrode of the first drive transistor M1. The first light-emitting control transistor M6 is connected between a second electrode of the first drive transistor M1 and the first node N1. The first data writing transistor M3 is connected between a pulse width data voltage line PWM_DATA (for ease of description, the pulse width data voltage line is denoted by the same reference signs as the pulse width data voltage) and the first electrode of the first drive transistor M1. The first compensation transistor M4 is connected between the second electrode and a gate of the first drive transistor M1. The first gate reset transistor M2 is connected between the gate of the first drive transistor M1 and a pulse width reset signal line PWM_REF. A first plate of the first capacitor C1 is connected to the gate of the first drive transistor M1, and a second plate of the first capacitor C1 receives the sweep driving signal SWEEP. A gate of the first gate reset transistor M2 receives a first pulse width scan signal PWM_S1, and gates of the first data writing transistor M3 and the first compensation transistor M4 receive a second pulse width scan signal PWM_S2. Gates of the first light-emitting control transistor M6 and the second light-emitting control transistor M5 receive a second light-emitting control signal PWM_EM, respectively.

The pulse amplitude modulation module 20 includes a second gate reset transistor M8, a second data writing transistor M9, a second compensation transistor M10, an electrode reset transistor M13 and a second capacitor C2.

The third light-emitting control transistor M11 is connected between a first power signal line PAM_PVDD and a first electrode of the second drive transistor M7. The fourth light-emitting control transistor M12 is connected between a second electrode of the second drive transistor M7 and the light-emitting element 12. The second drive transistor M7 generates a driving current under the control of its gate voltage. The gate of the second drive transistor M7 is electrically connected to the first node N1 to receive a pulse width setting signal output by the pulse width modulation module 10. The second data writing transistor M9 is connected between a amplitude data voltage line PAM_DATA (for ease of description, the amplitude data voltage line is donated by the same reference signs as the amplitude data voltage) and the first electrode of the second drive transistor M7. The second compensation transistor M10 is connected between the second electrode and a gate of the second drive transistor M7. The second gate reset transistor M8 is connected between the gate of the second drive transistor M7 and a amplitude reset signal line PAM_REF. The electrode reset transistor M13 is connected to a first electrode of the light-emitting element 12. The fourth light-emitting control transistor M12 is also connected to the first electrode of the light-emitting element 12. A second electrode of the light-emitting element 12 is connected to a third power signal line PVEE. A gate of the second gate reset transistor M8 receives a first amplitude scan signal PAM_S1, and gates of the second data writing transistor M9, the second compensation transistor M10, and the electrode reset transistor M13 receive a second amplitude scan signal PAM_S2. Gates of the third light-emitting control transistor M11 and the fourth light-emitting control transistor M12 receive the amplitude light-emitting control signal PAM_EM, respectively.

It should be noted that the connection of a first electrode of the electrode reset transistor M13 to the third power signal line PVEE as shown in FIG. 1 is for illustrative purposes only. In some embodiments, the first electrode of the electrode reset transistor M13 may also receive a amplitude reset signal PAM_REF. That is, the first electrode of the electrode reset transistor M13 and the first electrode of the second gate reset transistor M8 receive same signals. In some embodiments, the first electrode of the electrode reset transistor M13 is not connected to the third power signal line PVEE, and the first electrode of the electrode reset transistor M13 and the first electrode of the second gate reset transistor M8 receive different signals, which are not illustrated herein.

In some embodiments of the present disclosure, the light-emitting element 12 may be a light-emitting diode (LED), including a mini light-emitting diode (Mini LED), a micro light-emitting diode (Micro LED) or an organic light-emitting diode (OLED), etc., which may be designed according to actual conditions during specific implementation.

FIG. 2 is an operation timing diagram of a pixel driving circuit according to some embodiments of the present disclosure. As shown in FIG. 2, in some embodiments of the present disclosure, for one sub-pixel, a frame F includes at least two sub-frames SF during the operating process. FIG. 2 illustrates that the frame F includes two sub-frames, which are labeled SF_1 and SF_2, respectively.

As shown in FIG. 2, the sub-frame SF includes a light-emitting period Te during which the light-emitting control signal is at the enable level. In some embodiments of the present disclosure, the light-emitting control signal includes the amplitude light-emitting control signal PAM_EM shown in FIG. 1. That is, the duration of the light-emitting period Te is the width of the effective pulse of the amplitude light-emitting control signal PAM_EM.

In some embodiments of the present disclosure, as shown in FIG. 2, within one frame F, the durations of the light-emitting periods of one sub-pixel are different within at least two sub-frames SF. FIG. 2 illustrates that the duration of the light-emitting period of the sub-pixel within the sub-frame SF_1 is Te_1, and the duration of the light-emitting period within the sub-frame SF_2 is Te_2, where Te_1<Te_2.

During the operation of the pixel driving circuit, as shown in FIG. 2, at least within the first sub-frame SF_1, in addition to the light-emitting period Te, the operating process of the pixel driving circuit also includes a first data input stage Tw1 and a second data input stage Tw2 located before the light-emitting period Te.

In the first data input stage Tw1, the pulse amplitude modulation module 20 sequentially performs a first gate reset stage t11 and a first data writing stage t12.

In the first gate reset stage t11, the first scan signal PAM_S1 is at the enable level to control the second gate reset transistor M8 to turn on, and the second reset signal PAM_REF is written into a gate of the first drive transistor M7 to reset the gate of the first drive transistor M7.

In the first data writing stage t12, a second scan signal PAM_S2 is at the enable level to control the second data writing transistor M9 and the second compensation transistor M10 to turn on, the amplitude data voltage PAM_DATA is written into the gate of the first drive transistor M7 to perform threshold compensation.

In the second data input stage Tw2, the pulse width modulation module 10 sequentially performs a second gate reset stage t21 and a second data writing stage t22.

In the second gate reset stage t21, a third scan signal PWM_S1 is at the enable level to control the first gate reset transistor M2 to turn on, and a third reset signal PWM_REF is written into a gate of the second drive transistor M1 to reset the gate of the second drive transistor M1.

In the second data writing stage t22, a fourth scan signal PWM_S2 is at the enable level to control the first data writing transistor M3 and the first compensation transistor M4 to turn on, the pulse width data voltage PWM_DATA is written into the gate of the second drive transistor M1 to perform threshold compensation.

Then, the light-emitting period Te is entered. In the light-emitting period Te, the amplitude light-emitting control signal PAM_EM controls the second control transistor M11 and the fourth control transistor M12 to turn on, and the first drive transistor M7 generates a driving current under the control of its gate voltage, and the pulse amplitude modulation module 20 provides a driving current to the light-emitting element 12.

Furthermore, a first light-emitting control signal PWM_EM controls the first control transistor M6 and the third control transistor M5 to turn on. During the light-emitting period Te, the voltage value of the sweep driving signal SWEEP (denoted by the same reference signs as the sweep driving signal terminal SWEEP) gradually changes. Under the coupling action of the first capacitor C1, a gate voltage of the second drive transistor M1 changes. As shown in FIG. 2, the sweep driving signal SWEEP may include a sweep pulse in the form of a triangular wave in each sub-frame SF. During the light-emitting period Te, the sweep driving signal SWEEP linearly decreases from a first voltage VGH to a second voltage VGL. Furthermore, at the end of the light-emitting period Te, the sweep driving signal SWEEP may immediately increase from the second voltage VGL to the first voltage VGH. When the gate voltage of the second drive transistor M1 is equal to or less than the difference between its source voltage and the absolute value of the threshold voltage, the second drive transistor M1 turns on, a cutoff voltage is written into the gate of the first drive transistor M7, so that the first drive transistor M7 turns off to stop providing driving current to the light-emitting element 12.

It can be seen that in some embodiments of the present disclosure, during the light-emitting period Te, the pulse width modulation module 10 can write the cutoff voltage into the pulse amplitude modulation module 20 under the control of the pulse width data voltage PWM_DATA and the sweep driving signal SWEEP to control the supply duration of the driving current, thereby modulating the actual light-emitting period of the light-emitting element 12, and thus controlling the brightness and grayscale of the light-emitting element 12.

It can be understood that the light-emitting period Te is not the actual light-emitting period of the light-emitting element 12. The actual light-emitting period of the light-emitting element 12 is within the light-emitting period Te, and the actual light-emitting period of the light-emitting element 12 is related to the grayscale of the sub-pixel, i.e., the pulse width data voltage PWM_DATA.

In some embodiments of the present disclosure, when the sub-pixel is lit at the maximum grayscale, such as grayscale 255, the writing moment of the cutoff voltage may be located after the end moment of the enable level of the amplitude light-emitting control signal PAM_EM. That is, the actual light-emitting period of the sub-pixel is the stage during which the pulse width light-emitting control signal PAM_EM is at the enable level.

When the sub-pixel is lit at the minimum grayscale, such as grayscale 0, the writing moment of the cutoff voltage may be located before the start moment of the enable level of the amplitude light-emitting control signal PAM_EM. That is, the actual light-emitting period of the sub-pixel is 0.

When the sub-pixel is lit at a grayscale between the minimum grayscale and the maximum grayscale, the writing moment of the cutoff voltage is between the start and end moments of the enable level of the amplitude light-emitting control signal PAM_EM. That is, the actual light-emitting period of the sub-pixel is the time period from the start moment of the enable level of the amplitude light-emitting control signal PAM_EM to the writing moment of the cutoff voltage. That is, in this case, the light-emitting period Te further includes the non-light-emitting period from the writing moment of the cutoff voltage to the start moment of the enable level of the amplitude light-emitting control signal PAM_EM.

In some embodiments of the present disclosure, the light-emitting period Te can be understood as the maximum value of the actual light-emitting period.

FIG. 2 illustrates time point a and time point c, which are the writing moments of the cutoff voltage of the sub-pixel lit at a first grayscale within two sub-frames SF, i.e., the cutoff time points of the second drive transistor M7 within the two sub-frames SF. As shown in FIG. 2, within the second sub-frame SF_2, the period between the start moment of the enable level of the amplitude light-emitting control signal PAM_EM and the time point c is the actual light-emitting period d of the light-emitting element 12 within the second sub-frame SF_2.

In some embodiments of the present disclosure, within the sub-frame SF after the first sub-frame SF_1, such as the second sub-frame SF_2 shown in FIG. 2, the operating process of the sub-pixel may not include the first gate reset stage t11, the second gate reset stage t21, and the second data writing stage t22.

For the display panel according to the embodiments of the present disclosure, by setting the operating process of the sub-pixel within the frame F to include at least two sub-frames SF, and setting the light-emitting period Te within each sub-frame SF, the number of light-emitting times of the sub-pixel within one frame can be increased, and the time interval between two adjacent light emissions can be shortened, which is conducive to alleviating the flicker problem.

Moreover, in the embodiments of the present disclosure, by setting the duration of the light-emitting period of the sub-pixel within different sub-frames SF within the frame F to be different, the sub-pixel can emit light multiple times within one frame, and the actual light-emitting period of the sub-pixel within different sub-frames can be set in a differentiated manner.

In some embodiments of the present disclosure, when the sub-pixel is lit at a low grayscale, the actual light-emitting period of the sub-pixel within the sub-frame SF with a shorter light-emitting period may be 0. That is, the sub-pixel does not emit light within the sub-frame SF with a shorter light-emitting period, thereby reducing the number of times the sub-pixel emits light within a frame at a low grayscale, and thus slowing down the brightness change rate of the sub-pixel at a low grayscale.

During the implementation of the embodiments of the present disclosure, the inventors discovered that, in the display panel using the PWM+PAM driving architecture in the related art, the actual light-emitting period of the sub-pixel is linearly related to the pulse width data voltage PWM_DATA. However, for the currently popular gamma curve, the relationship between grayscale and brightness is not linear. Furthermore, low grayscales are more sensitive to changes in brightness. Therefore, in the related art, brightness control at low grayscales is more difficult, and has higher requirements for control signals.

In some embodiments of the present disclosure, the brightness of the sub-pixel in the low grayscale range can change slowly as the pulse width data voltage PWM_DATA changes, which is conducive to improving the brightness control accuracy in the low grayscale range.

Referring to FIG. 2, for one sub-pixel, one frame F includes at least the first sub-frame SF_1 and the second sub-frame SF_2 during the operating process.

Within the first sub-frame SF_1, a time interval between a start moment at which the pulse width light-emitting control signal PWM_EM is at the enable level and a start moment of the amplitude light-emitting control signal PAM_EM is at the enable level is ta1. A time interval between a start moment of a linear change of the sweep driving signal SWEEP and the start moment at which the amplitude light-emitting control signal PAM_EM is at the enable level is ta3.

Within the second sub-frame SF_2, a time interval between a start moment at which the pulse width light-emitting control signal PWM_EM is at the enable level and a start moment at which the amplitude light-emitting control signal PAM_EM is at the enable level is tb1. A time interval between a start moment of a linear change of the sweep driving signal SWEEP and the start moment at which the amplitude light-emitting control signal PAM_EM is at the enable level is tb3.

In some embodiments of the present disclosure, ta1≠tb1 may be set. FIG2 illustrates ta>tb1.

In some embodiments of the present disclosure, ta3≠tb3 may be set. FIG2 illustrates ta3>tb3.

In some embodiments of the present disclosure, within the first sub-frame SF_1, by setting the time interval ta1 or the time interval ta3 to be larger, when the sub-pixel is lit at part of low grayscales (as shown in FIG. 2, when the sub-pixel is lit at a lower first grayscale), the start moment (such as the falling edge of the low-level pulse) of the enable level (such as the low level) of the amplitude light-emitting control signal PAM_EM can be located after the writing moment a of the cutoff voltage corresponding to the first grayscale. That is, before the amplitude light-emitting control signal PAM_EM is switched to the enable level, the cutoff voltage for controlling the flow path of the driving current provided by the pulse width modulation module 10 has been written into the pulse amplitude modulation module 20. Therefore, when displaying at the first grayscale, the light-emitting element 12 may not emit light at least within the first sub-frame SF_1.

In some embodiments of the present disclosure, it can be seen that by setting ta1≠tb1 or ta3≠tb3, the light-emitting periods Te of the sub-pixel within different sub-frames SF can be set in a differentiated manner, and thus the actual light-emitting periods within the corresponding light-emitting periods can also be set in a differentiated manner. When the sub-pixel is displayed at relatively low grayscales, the actual light-emitting periods within the sub-frames SF where ta1 or ta3 are large can be set to 0. That is, the sub-pixel does not emit light within these sub-frames SF, thereby reducing the brightness change rate at low grayscales and improving the of brightness adjustment accuracy at low grayscales.

In some embodiments of the present disclosure, the time interval between the start moment of the linear change of the sweep driving signal SWEEP (such as the start moment at which the sweep driving signal SWEEP linearly decreases) and the writing moment of the cutoff voltage can be set to be the same in each sub-frame within one frame F. As shown in FIG. 2, within the first sub-frame SF_1, the time interval between the start moment of the linear change of the sweep driving signal SWEEP (such as the start moment at which the sweep driving signal SWEEP linearly decreases) and the writing moment a of the cutoff voltage corresponding to the first grayscale is b. Within the second sub-frame SF_2, the time interval between the start moment of the linear change of the sweep driving signal SWEEP (such as the start moment at which the sweep driving signal SWEEP linearly decreases) and the writing moment c of the cutoff voltage corresponding to the first grayscale is d, where b=d.

In some embodiments of the present disclosure, as shown in FIG. 2, within the second sub-frame SF_2, since the time interval tb1 or tb3 is relatively short, the start moment at which the amplitude light-emitting control signal PAM_EM is at the enable level (such as the falling edge of the low-level pulse) is located before the writing moment c of the cutoff voltage corresponding to the first grayscale. Therefore, the actual light-emitting period within the second sub-frame SF_2 is d shown in FIG. 2.

In some embodiments of the present disclosure, the waveforms of the sweep driving signal SWEEP within at least two sub-frames SF may be set to be the same. The waveforms of the pulse width light-emitting control signal PWM_EM within at least two sub-frames SF may be set to be the same. The time interval between the start moment of the linear change of the sweep driving signal SWEEP and the start moment at which the pulse width light-emitting control signal PWM_EM is at the enable level within at least two sub-frames SF may be set to be the same.

In some embodiments of the present disclosure, as shown in FIG. 2, in some embodiments of the present disclosure, the waveforms of the linear change of the sweep driving signal SWEEP within the first sub-frame SF_1 and the second sub-frame SF_2 can be set to be the same. That is, the maximum value, minimum value, and linearly change slope of the sweep driving signal SWEEP within the first sub-frame SF_1 and the second sub-frame SF_2 are the same. Based on this configuration, the signal generating circuit that provides the sweep driving signal SWEEP can provide same signals within different sub-frames SF, which is conducive to reducing the design difficulty of the signal generating circuit that provides the sweep driving signal SWEEP.

It is understood that the writing moments a and c of the cutoff voltage shown in FIG. 2 are for illustrative purposes only. The writing moments of the cutoff voltage are related to the pulse width data voltage PWM_DATA and the sweep driving signal SWEEP. In some embodiments of the present disclosure, when displaying at different grayscales, the pulse width data voltage PWM_DATA will change, and the writing moment of the cutoff voltage will also change accordingly.

FIG. 2 also shows the writing moments e and f of the cutoff voltage corresponding to the second grayscale. The time e is within the first sub-frame SF_1 and the time f is within the second sub-frame SF_2.

In some embodiments of the present disclosure, as shown in FIG. 2, within the first sub-frame SF_1, the time interval g between the writing moment e of the cutoff voltage corresponding to the second grayscale and the start moment of the linear change of the sweep driving signal SWEEP is greater than the time interval b between the writing moment of the cutoff voltage corresponding to the first grayscale and the start moment of the linear change of the sweep driving signal SWEEP.

As shown in FIG. 2, within the second sub-frame SF_2, the time interval h between the writing moment f of the cutoff voltage corresponding to the second grayscale and the start moment of the linear change of the sweep driving signal SWEEP is greater than the time interval d between the writing moment c of the cutoff voltage corresponding to the first grayscale and the start moment of the linear change of the sweep driving signal SWEEP. Furthermore, h=g.

As shown in FIG. 2, When the sub-pixel is lit at the second grayscale, the actual light-emitting period within the first sub-frame SF_1 and the second sub-frame SF_2 may not be 0. Furthermore, the actual light-emitting period i of the sub-pixel within the first sub-frame SF_1 is less than the actual light-emitting period j within the second sub-frame SF_2.

In some embodiments of the present disclosure, as shown in FIG. 2, when the sub-pixel is lit at the first grayscale, the actual light-emitting period within the first sub-frame SF_1 is 0, and the actual light-emitting period within the second sub-frame SF_2 is d. When the sub-pixel is lit at the second grayscale, the actual light-emitting period within the first sub-frame SF_1 is i, and the actual light-emitting period within the second sub-frame SF_2 is j. In some embodiments of the present disclosure, i<j, and d<j.

In some embodiments of the present disclosure, the period when the amplitude light-emitting control signal PAM_EM is at the effective level is the light-emitting period Te. That is, the period when the amplitude light-emitting control signal PAM_EM is at the effective level defines the maximum value of the actual light-emitting period.

As shown in FIG. 2, within one frame F, the widths of the effective pulses of the amplitude light-emitting control signal PAM_EM within at least two sub-frames SF are different. FIG. 2 illustrates that the width of the effective pulse of the amplitude light-emitting control signal PAM_EM within the first sub-frame SF_1 is Te_1, and the width of the effective pulse of the amplitude light-emitting control signal PAM_EM within the second sub-frame SF_2 is Te_2, where Te_1<Te_2, so as to achieve different durations of the light-emitting periods of the sub-pixel within at least two sub-frames SF.

In some embodiments of the present disclosure, as shown in FIG. 2, the pulse width k1 of the enable level of the pulse width light-emitting control signal PWM_EM within the first sub-frame SF_1 is equal to the pulse width k2 of the enable level within the second sub-frame SF_2, so as to reduce the difficulty of generating the pulse width light-emitting control signal PWM_EM. The timing design is simple and easy to implement.

In some embodiments of the present disclosure, as shown in FIG. 2, the width q of the sweep pulse of the sweep driving signal SWEEP may be less than or equal to the widths k1 and k2 of the enable levels of the pulse width light-emitting control signal PWM_EM.

In some embodiments of the present disclosure, within the first sub-frame SF_1, the time interval between the end moment (e.g., the rising edge of the low-level pulse) of the enable level (such as the low-level pulse) of the pulse width light-emitting control signal PWM_EM and the end moment (e.g., the rising edge of the low-level pulse) of the enable level (such as the low-level pulse) of the amplitude light-emitting control signal PAM_EM is ta2. The time interval between the end moment of the linear change of the sweep driving signal SWEEP and the end moment of the enable level of the amplitude light-emitting control signal PAM_EM is ta4.

Within the second sub-frame SF_2, the time interval between the end moment of the enable level of the pulse width light-emitting control signal PWM_EM and the end moment of the enable level of the amplitude light-emitting control signal PAM_EM is tb2. The time interval between the end moment of the linear change of the sweep driving signal SWEEP and the end moment of the enable level of the amplitude light-emitting control signal PAM_EM is tb4.

As shown in FIG. 2, in some embodiments of the present disclosure, ta2=tb2 may be set. Based on this configuration, by merely adjusting ta1≠tb1, the durations of the light-emitting periods within different sub-frames can be set in a differentiated manner. The timing design is simple and easy to implement.

In some embodiments of the present disclosure, within one sub-frame SF, the end moment of the enable level of the pulse width light-emitting control signal PWM_EM is no earlier than the end moment of the enable level of the amplitude light-emitting control signal PAM_EM. In some embodiments of the present disclosure, as shown in FIG. 2, the end moment of the enable level of the pulse width light-emitting control signal PWM_EM may be later than the end moment of the enable level of the amplitude light-emitting control signal PAM_EM, or the two may be the same, that is, ta2=tb2=0.

In some embodiments of the present disclosure, ta4=tb4 may be set. Based on this configuration, by merely adjusting ta3≠tb3, the durations of the light-emitting periods Te within different sub-frames SF can be set in a differentiated manner. The timing design is simple and easy to implement. FIG. 2 illustrates that within one sub-frame SF, the end moment of the linear change of the sweep driving signal SWEEP can be aligned with the end moment of the enable level of the amplitude-light-emitting control signal PAM_EM, i.e., ta4=tb4=0.

In some embodiments of the present disclosure, as shown in FIG. 2, within one sub-frame SF, the start moment at which the pulse width light-emitting control signal PWM_EM is at the enable level is no later than the start moment at which the amplitude light-emitting control signal PAM_EM is at the enable level.

FIG. 2 illustrates that within one sub-frame SF, the start moment at which the pulse width light-emitting control signal PWM_EM is at the enable level is earlier than the start moment at which the amplitude light-emitting control signal PAM_EM is at the enable level. The start moment at which the pulse width light-emitting control signal PWM_EM is at the enable level may also be set to be the same as the start moment at which the amplitude light-emitting control signal PAM_EM is at the enable level.

Based on this configuration, it can be ensured that when the amplitude light-emitting control signal PAM_EM is at the enable level to control the third light-emitting control transistor M11 and the fourth light-emitting control transistor M12 to be conductive, the pulse width light-emitting control signal PWM_EM has switched to the enable level, thereby ensuring that when the amplitude light-emitting control signal PAM_EM is at the enable level to control the third light-emitting control transistor M11 and the fourth light-emitting control transistor M12 to be conductive, the driving current generated by the second drive transistor M7 can be determined solely by the conductive state of the second drive transistor M7 to determine whether it flows through the light-emitting element 12. In some embodiments of the present disclosure, when the second light-emitting control signal PWM_EM is at the enable level to control the first light-emitting control transistor M6 and the second light-emitting control transistor M5 to be conductive, the pulse width modulation module 10 outputs the cutoff voltage to the pulse amplitude modulation module 20, and the driving current stops flowing through the light-emitting element 12.

In some embodiments of the present disclosure, for one sub-pixel, the frame F may include at least three sub-frames SF during the operating process. FIG. 3 is an operation timing diagram of a further pixel driving circuit according to some embodiments of the present disclosure. As shown in FIG. 3, other signals except the pulse width light-emitting control signal PWM_EM, the amplitude light-emitting control signal PAM_EM, and the sweep driving signal SWEEP are omitted. The operating process of the sub-pixel within the frame F includes at least the first sub-frame SF_1, the second sub-frame SF_2, a third sub-frame SF_3, and a fourth sub-frame SF_4, which are performed in chronological order.

Within the first sub-frame SF_1, the time interval between the start moment of the enable level of the pulse width light-emitting control signal PWM_EM and the start moment of the enable level of the amplitude light-emitting control signal PAM_EM is ta1, and the time interval between the start moment of the linear change of the sweep driving signal SWEEP and the start moment of the enable level of the amplitude light-emitting control signal PAM_EM is ta3.

Within the second sub-frame SF_2, the time interval between the start moment of the enable level of the pulse width light-emitting control signal PWM_EM and the start moment of the enable level of the amplitude light-emitting control signal PAM_EM is tb1, and the time interval between the start moment of the linear change of the sweep driving signal SWEEP and the start moment of the enable level of the amplitude light-emitting control signal PAM_EM is tb3.

Within the third sub-frame SF_3, the time interval between the start moment of the enable level of the pulse width light-emitting control signal PWM_EM and the start moment of the enable level of the amplitude light-emitting control signal PAM_EM is tc1, and the time interval between the start moment of the linear change of the sweep driving signal SWEEP and the start moment of the enable level of the amplitude light-emitting control signal PAM_EM is tc3.

Within the fourth sub-frame SF_4, the time interval between the start moment of the enable level of the pulse width light-emitting control signal PWM_EM and the start moment of the enable level of the amplitude light-emitting control signal PAM_EM is td1, and the time interval between the start moment of the linear change of the sweep driving signal SWEEP and the start moment of the enable level of the amplitude light-emitting control signal PAM_EM is td3.

In some embodiments of the present disclosure, ta1=tc1, tb1=td1, and ta1≠tb1 may be set. FIG. 3 illustrates that ta1=tc1>tb1=td1.

In some embodiments of the present disclosure, ta3=tc3, tb3=td3, and ta3≠tb3 may be set. FIG. 3 illustrates that ta3=tc3>tb3=td3.

Based on this configuration, on the one hand, the light-emitting periods of the sub-pixel within at least two sub-frames SF can be set in a differentiated manner. On the other hand, by setting ta1=tc1 or ta3=tc3, the regularity of the pulse width light-emitting control signal PWM_EM, the amplitude light-emitting control signal PAM_EM and sweep driving signal SWEEP can be improved, which can reduce the difficulty of generating the signals, and is conducive to improving the brightness uniformity within different sub-frames and avoiding flicker. Furthermore, in some embodiments of the present disclosure, by setting the interval between two sub-frames SF within same light-emitting periods, the two sub-frames with the same light-emitting period can be dispersed as much as possible within different sub-frames SF of the frame F, which is conducive to improving the brightness uniformity of different periods within one frame F and avoiding flicker.

In some embodiments of the present disclosure, within at least three sub-frames SF, the time interval between the start moment at which the pulse width light-emitting control signal PWM_EM is at the enable level and the start moment at which the amplitude light-emitting control signal PAM_EM is at the enable level gradually increases over time.

In some embodiments of the present disclosure, within at least three sub-frames, the time interval between the start moment of the linear change of the sweep driving signal SWEEP and the start moment at which the amplitude light-emitting control signal PAM_EM is at the enable level gradually increases over time.

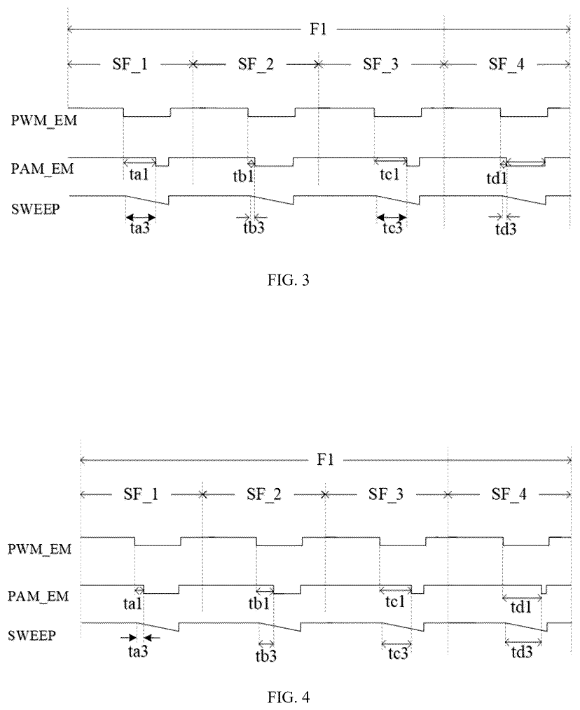

FIG. 4 is an operation timing diagram of a further pixel driving circuit according to some embodiments of the present disclosure. As shown in FIG. 4, other signals except the pulse width light-emitting control signal PWM_EM, the amplitude light-emitting control signal PAM_EM, and the sweep driving signal SWEEP are omitted. FIG. 4 illustrates that ta1<tb1<tc1<td1, and ta3<tb3<tc3<td3.

Based on this configuration, the actual light-emitting periods within different sub-frames may gradually change over time. In some embodiments of the present disclosure, the actual light-emitting periods of the sub-pixel within different sub-frames may gradually increase or decrease, thereby avoiding obvious flicker problems caused by large brightness differences between two adjacent sub-frames due to large duration differences.

FIG. 5 is an operation timing diagram of a further pixel driving circuit according to some embodiments of the present disclosure. In the embodiment of the present disclosure, ta2≠tb2 can be set. FIG. 5 illustrates that ta2>tb2.

Based on this configuration, the durations of the light-emitting periods Te within the first sub-frame SF_1 and the second sub-frame SF_2 can be set in a differentiated manner.

In some embodiments of the present disclosure, as shown in FIG. 5, the end moment (such as the rising edge of the low-level pulse) of the enable level of the amplitude light-emitting control signal PAM_EM is located before the end moment of the linear change of the sweep driving signal SWEEP.

As shown in FIG. 5, in some embodiments of the present disclosure, ta1=tb1 may be set.

Based on this configuration, when the sub-pixel is lit at a low grayscale, within at least part of the sub-frames SF, the writing moment of the cutoff voltage corresponding to the lighting grayscale may be located after the end moment of the enable level of the amplitude light-emitting control signal PAM_EM. That is, the actual light-emitting period of the sub-pixel within the corresponding sub-frame SF is the duration between the start moment and the end moment of the enable level of the amplitude light-emitting control signal PAM_EM. Therefore, in this embodiment of the present disclosure, by adjusting the time interval between the end moment of the enable level of the amplitude light-emitting control signal PAM_EM and the end moment of the enable level of the pulse width light-emitting control signal PWM_EM within different sub-frames SF, the actual light-emitting period of the sub-pixel within the corresponding sub-frame can be adjusted.

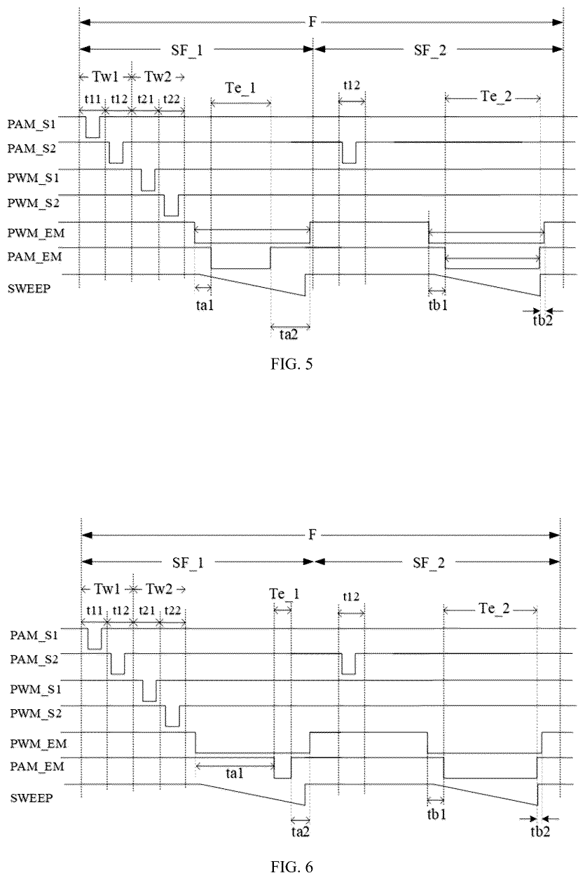

FIG. 6 is an operation timing diagram of a further pixel driving circuit according to some embodiments of the present disclosure. In some embodiments of the present disclosure, as shown in FIG. 6, ta1≠tb1, and ta2≠tb2, so that the durations of the light-emitting periods Te within the first sub-frame SF_1 and the second sub-frame SF_2 are set in a differentiated manner.

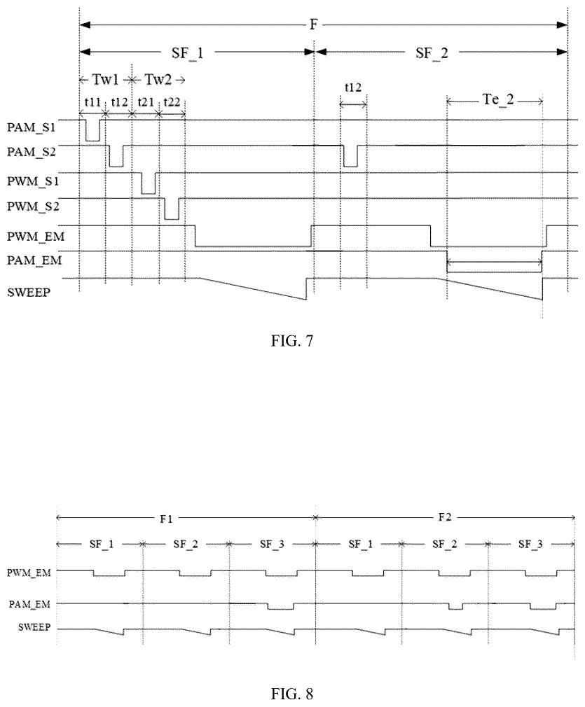

In some embodiments of the present disclosure, within one frame, the sub-pixel does not emit light within at least one sub-frame. That is, within at least one sub-frame, the pulse width of the effective level of the amplitude light-emitting control signal PAM_EM is 0. FIG. 7 is a further operation timing diagram according to some embodiments of the present disclosure. In some embodiments of the present disclosure, as shown in FIG. 7, the sub-pixel does not emit light within at least the first sub-frame SF_1. Based on this configuration, the total number of times the sub-pixel emits light within the frame F can be reduced, thereby reducing the brightness increase rate of the sub-pixel and improving the brightness control accuracy of the sub-pixel.

FIG. 8 is an operation timing diagram of a further pixel driving circuit according to some embodiments of the present disclosure. As shown in FIG. 8, the sub-pixel operates within a first frame F1 and a second frame F2. The brightness of the sub-pixel within the first frame F1 is lower than that within the second frame F2. In this embodiment of the present disclosure, the number of sub-frames of the first frame F1 that do not emit light is greater than the number of sub-frames of the second frame F2 that do not emit light. Based on this configuration, the brightness of the sub-pixel within the first frame F1 is lower than that within the second frame F2. FIG. 8 illustrates that both the first frame F1 and the second frame F2 include three sub-frames SF. Within the first frame F1, only the third sub-frame SF_3 as a sub-frame SF includes the pulse of the effective level of the amplitude light-emitting control signal PAM_EM. The first sub-frame SF_1 and the second sub-frame SF_2 do not include the pulse of the effective level of the amplitude light-emitting control signal PAM_EM. Within the second frame F2, only the first sub-frame SF_1 as a sub-frame SF does not include the pulse of the effective level of the amplitude light-emitting control signal PAM_EM.

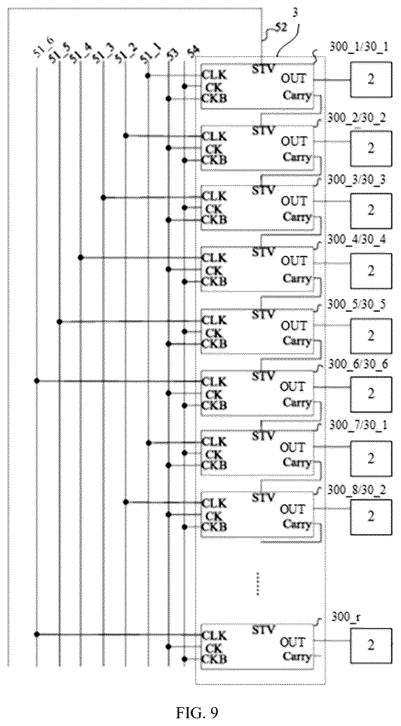

FIG. 9 is a schematic diagram of a display panel according to some embodiments of the present disclosure. In some embodiments of the present disclosure, as shown in FIG. 9, the display panel includes a driving circuit 3 and r pixel rows 2. The pixel row 2 includes a plurality of the above sub-pixels.

As shown in FIG. 9, the driving circuit 3 includes a plurality of cascaded driving units 300, which are configured to output the amplitude light-emitting control signal PAM_EM to the pixel rows 2. That is, the plurality of sub-pixels in one pixel row 2 receive same amplitude light-emitting control signals PAM_EM.

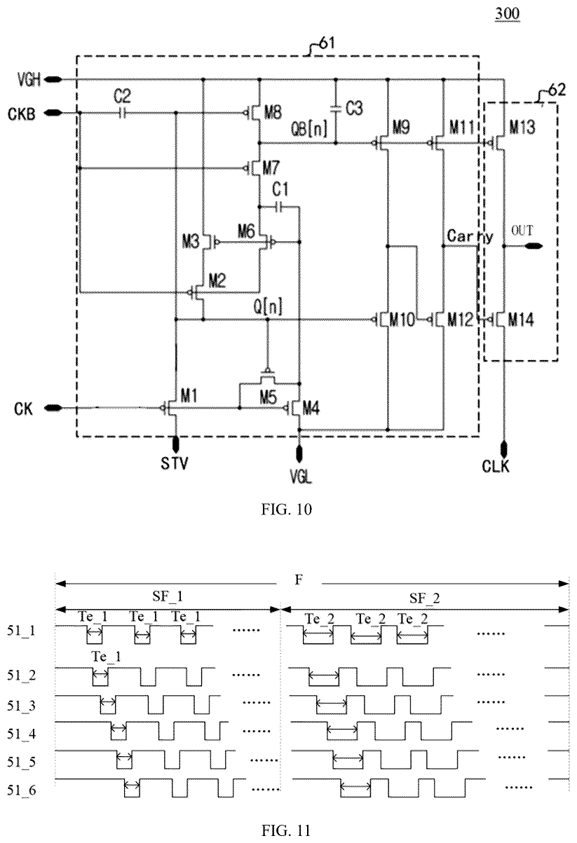

FIG. 10 is a schematic circuit diagram of a driving unit according to some embodiments of the present disclosure. As shown in FIG. 10, the driving unit 300 includes a first input terminal CLK, which is configured to transmit a first input signal CLK (donated by the same reference sign as the first input terminal). Under the action of the first control signal Carry, the first input signal CLK is output as the amplitude light-emitting control signal PAM_EM during the light-emitting period Te. That is, the amplitude light-emitting control signal PAM_EM is generated by the driving unit 300.

As shown in FIG. 10, the driving unit 300 includes a first output transistor M14, a first electrode of the first output transistor M14 is connected to the first input terminal CLK, a second electrode of the first output transistor M14 is connected to the output terminal OUT of the driving unit 300, and the output terminal OUT of the driving unit 300 outputs the amplitude light-emitting control signal PAM_EM.

As shown in FIG. 10, the driving unit 300 includes a driving module 61 and a gating module 62. The gating module 62 includes the first output transistor M14. The output terminal Carry of the driving module 61 is connected to a trigger signal terminal STV of the next-stage driving unit 300, and the output terminal Carry of the driving module 61 is connected to the gate of the first output transistor M14. An output terminal of the gating module 62 outputs the amplitude light-emitting control signal PAM_EM.

FIG. 11 is a schematic diagram of signals of a first input signal line according to some embodiments of the present disclosure. In some embodiments of the present disclosure, as shown in FIG. 11, within different sub-frames SF of the frame F, the widths of the effective pulses of the first input signal CLK provided by a first input signal line 51 corresponding to one pixel row 2 are different. FIG. 11 illustrates that the frame F includes two sub-frames SF. Taking the connection of the first input signal line 51 as shown in FIG. 9 as an example, that is, the first driving unit 300_1, the seventh driving unit 300_7, the thirteenth driving unit 300_13, etc. are connected to the first input signal line 51_1, the first effective pulse of the first input signal line 51_1 within each sub-frame SF is provided to the first driving unit 300_1, which in turn is provided to the first pixel row 2, the second effective pulse is provided to the seventh driving unit 300_7, which in turn is provided to the seventh pixel row, and the third effective pulse is provided to the thirteenth driving unit 300_13, which in turn is provided to the thirteenth pixel row. The widths of the effective pulses of the first input signal CLK provided by the first input signal line 51 corresponding to one pixel row 2 are different, which can be understood as follows: the width of the u-th effective pulse of the first input signal line 51 within each sub-frame SF is different. u represents any one of the plurality of effective pulses of the first input signal line 51 within each sub-frame SF. In some embodiments of the present disclosure, the width of the first effective pulse of the first input signal line 51 in each sub-frame SF is different, the width of the second effective pulse of the first input signal line 51 in each sub-frame SF is different, and so on. Based on this configuration, the widths of the effective pulses of the amplitude light-emitting control signal PAM_EM provided to one pixel row 2 within different sub-frames SF can be different, and the light-emitting periods of the same sub-pixel within different sub-frames SF of one frame can be set in a differentiated manner.

In some embodiments of the present disclosure, as shown in FIG. 9, the display panel further includes the first input signal line 51, a second input signal line 52, a first clock signal line 53, and a second clock signal line 54 that are electrically connected to the driving circuit 3. The first input terminal CLK of the driving unit 300 is electrically connected to the first input signal line 51, the trigger signal terminal STV of the first-stage driving unit 300_1 is electrically connected to the second input signal line 52, the first clock signal line 53 is connected to a first clock signal terminal CKB of the odd-stage driving unit 300, and the second clock signal line 54 is connected to a second clock signal terminal CK of the even-stage driving unit 300.

As shown in FIG. 9, the driving circuit 3 includes m driving unit groups 30, the driving unit group 30 includes a plurality of driving units 30. The plurality of driving units 30 in one driving unit group 30 are connected to the first input signal line 51 to receive the first input signal CLK. The driving units in different driving unit groups 30 are connected to different first input signal lines 51 to receive different first input signals CLK.

FIG. 9 illustrates that m=6, that is, the display panel includes six first input signal lines 51, and the driving circuit 3 includes six driving unit groups 30. For distinction, the six first input signal lines 51 are marked as 51_1, 51_2, 51_3, 51_4, 51_5, and 51_6, respectively, and the six driving unit groups 30 are marked as 30_1, 30_2, 30_3, 30_4, 30_5, and 30_6, respectively.

The driving unit group 30_1 includes the first-stage driving unit 300_1, the seventh-stage driving unit 300_7, the thirteenth-stage driving unit 300_13, etc. The driving unit group 30_2 includes a second-stage driving unit 300_2, an eighth-stage driving unit 300_8, a fourteenth-stage driving unit 300_14, etc. The rule for the driving units included in the other driving unit groups follows accordingly. That is, the first-stage driving units 300_1 to the sixth-stage driving units 300_6 are sequentially connected to the first input signal line 51_1 to the first input signal line 51_6, the seventh-stage driving units 300_7 to the twelfth-stage driving units 300_12 are sequentially connected to the first input signal line 51_1 to the first input signal line 51_6, the thirteenth-stage driving units 300_13 to the eighteenth-stage driving units 300_18 are sequentially connected to the first input signal line 51_1 to the first input signal line 51_6, and so on.

Based on this configuration, compared with the method of providing only one first input signal line 51 to connect all driving units 300, the number of driving units 300 connected to a single first input signal line 51 can be reduced, the load of the first input signal line 51 can be reduced, thereby reducing the signal delay time and in-plane non-uniformity, and improving the display effect.

In some embodiments of the present disclosure, r is an integer multiple of m, so that the number of the pixel rows 2 connected to different first input signal lines 51 can be consistent, which is conducive to balancing the loads of different first input signal lines 51.

In some embodiments of the present disclosure, the frame F includes n sub-frames SF, r/m is an integer multiple of n, where r/m can be the number of the pixel rows 2 connected to one first input signal line 51, and the number of the sub-frames SF of the frame F is the number of times the sub-pixel emits light within one frame SF.

In some embodiments of the present disclosure, referring to FIG. 11, within one sub-frame SF, the first input signal CLK provided by the first input signal line 51 includes a plurality of effective pulses, and the widths of the plurality of effective pulses within the sub-frame SF are equal. FIG. 11 illustrates that the widths of the plurality of effective pulses within the first sub-frame SF_1 are all Te_1, and the widths of the plurality of effective pulses within the second sub-frame SF_2 are all Te_2.

The plurality of effective pulses of the first input signal line 51 within the sub-frame SF are provided to the plurality of driving units 300 electrically connected to the first input signal line 51, respectively, and then provided to the plurality of different pixel rows 2 electrically connected to the plurality of driving units 300. In this embodiment of the present disclosure, by making the widths of the multiple effective pulses of the first input signal CLK provided by the first input signal line 51 within the sub-frame SF be equal, the sub-pixels in the multiple different pixel rows 2 can have same light-emitting periods within one sub-frame SF, thereby avoiding the problem of uneven display caused by inconsistent brightness in different areas.

In some embodiments of the present disclosure, as shown in FIG. 11, the widths of the effective pulses of the first input signals CLK provided by different first input signal lines 51 within the sub-frame SF are equal. FIG. 11 illustrates that the widths of the effective pulses of the first input signals CLK provided by the first input signal line 51_1, the first input signal line 51_2, . . . , and the first input signal line 51_6 within the first sub-frame SF1 are all Te_1, and the widths of the effective pulses of the first input signals CLK within the second sub-frame SF2 are all Te_2. Based on this configuration, the light-emitting periods of the sub-pixels in the plurality of different pixel rows 2 within the sub-frame SF can be consistent, thereby avoiding the problem of uneven display due to inconsistent brightness in different areas.

Based on the same inventive concept, an embodiment of the present disclosure further provides a driving method for a display panel. The driving method is applied to the above display panel. The display panel includes a plurality of sub-pixels. As shown in FIG. 2, the driving method for the display panel according to the embodiment of the present disclosure includes: for one sub-pixel, one frame F is controlled to include at least two sub-frames SF during the operating process, and the at least two sub-frames SF includes light-emitting periods Te during one of which the light-emitting control signal is at an enable level. Moreover, within the frame F, the durations of the light-emitting periods Te of the sub-pixel 1 are different within at least two sub-frames SF.

Based on this configuration, by setting the sub-pixel to include at least two sub-frames SF during the operating process within one frame F, and setting the light-emitting period Te within each sub-frame SF, the number of light-emitting times of the sub-pixel within one frame can be increased, and the time interval between two adjacent light emissions can be shortened, which is conducive to alleviating the flicker problem.

Moreover, in some embodiments of the present disclosure, by setting the durations of the light-emitting periods of the sub-pixel within different sub-frames SF of one frame F to be different, the actual light-emitting periods of the sub-pixel within different sub-frames can be set in a differentiated manner, which is conducive to improving the brightness control accuracy at low grayscales.

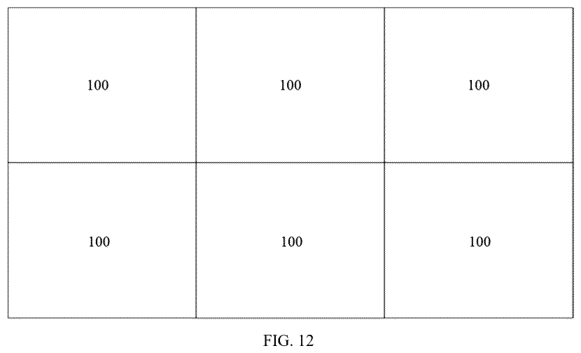

Based on the same inventive concept, an embodiment of the present disclosure further provides a display apparatus. FIG. 12 is a schematic diagram of a display apparatus according to some embodiments of the present disclosure. The display apparatus includes the display panel 100. The structure of the display panel 100 has been described in detail in the above embodiments and will not be elaborated here.

In some embodiments of the present disclosure, as shown in FIG. 12, the display apparatus includes a spliced display apparatus. The spliced display apparatus includes at least two of the display panels 100, so as to be applicable to a large-screen display apparatus with a display function, such as a frameless spliced display apparatus.

In some embodiments of the present disclosure, this type of spliced display apparatus can be applied in public information display (PID) scenarios such as stations and airports. When the spliced display apparatus includes the display panel 100, a seamless/borderless splicing effect of the spliced display apparatus can be achieved.

The above are merely exemplary embodiments of the present disclosure, which, as mentioned above, are not used to limit the present disclosure. Whatever within the principles of the present disclosure, including any modification, equivalent substitution, improvement, etc., shall fall into the protection scope of the present disclosure.

Finally, it should be noted that the technical solutions of the present disclosure are illustrated by the above embodiments, but not intended to limit thereto. Although the present disclosure has been described in detail with reference to the foregoing embodiments, those skilled in the art can understand that the present disclosure is not limited to the specific embodiments described herein, and can make various modifications, readjustments, and substitutions without departing from the scope of the present disclosure.

What is claimed is:

1. A display panel, comprising a plurality of sub-pixels;
wherein, for one of the plurality of sub-pixels, a frame comprises at least two sub-frames, the at least two sub-frames comprises light-emitting periods during one of which a light-emitting control signal is at an enable level; and
within the frame, durations of the light-emitting periods of one of the plurality of sub-pixels are different within the at least two sub-frames.

2. The display panel according to claim 1, wherein
one of the plurality of sub-pixels comprises a pixel driving circuit and a light-emitting element that are electrically connected to each other;
the pixel driving circuit comprises a pulse width modulation module and a pulse amplitude modulation module that are electrically connected to each other;
the pulse amplitude modulation module is configured to control an amplitude of a driving current based on an applied amplitude data voltage, and the pulse width modulation module is configured to control a pulse width of the driving current;
the light-emitting control signal comprises an amplitude light-emitting control signal;
the pulse amplitude modulation module comprises a first light-emitting control unit, and the first light-emitting control unit turns on in response to the amplitude light-emitting control signal being at an enable level;
the pulse width modulation module comprises a second light-emitting control unit, and the second light-emitting control unit turns on in response to a pulse width light-emitting control signal being at an enable level;
for one of the plurality of sub-pixels, one frame comprises at least a first sub-frame and a second sub-frame;
within the first sub-frame, a time interval between a start moment at which the pulse width light-emitting control signal is at the enable level and a start moment at which the amplitude light-emitting control signal is at the enable level is ta1;
within the second sub-frame, a time interval between a start moment at which the pulse width light-emitting control signal is at the enable level and a start moment at which the amplitude light-emitting control signal is at the enable level is tb1; and
wherein ta1≠tb1.

3. The display panel according to claim 2, wherein
a pulse width of the enable level of the pulse width light-emitting control signal within the first sub-frame is the same as a pulse width of the enable level of the pulse width light-emitting control signal within the second sub-frame; and
a pulse width of the enable level of the amplitude light-emitting control signal within the first sub-frame is different from a pulse width of the enable level of the amplitude light-emitting control signal within the second sub-frame.

4. The display panel according to claim 2, wherein
within the first sub-frame, a time interval between an end moment at which the pulse width light-emitting control signal is at the enable level and an end moment at which the amplitude light-emitting control signal is at the enable level is ta2;
within the second sub-frame, a time interval between an end moment at which the pulse width light-emitting control signal is at the enable level and an end moment at which the amplitude light-emitting control signal is at the enable level is tb2; and
wherein ta2=tb2.

5. The display panel according to claim 2, wherein
within one sub-frame, the start moment at which the pulse width light-emitting control signal is at the enable level is not later than the start moment at which the amplitude light-emitting control signal is at the enable level.

6. The display panel according to claim 2, wherein
for one of the plurality of sub-pixels, one frame comprises at least the first sub-frame, the second sub-frame, and a third sub-frame, the second sub-frame is between the first sub-frame and the third sub-frame;
the time interval between the start moment at which the pulse width light-emitting control signal is at the enable level and the start moment at which the amplitude light-emitting control signal is at the enable level within the first sub-frame is equal to the time interval between the start moment at which the pulse width light-emitting control signal is at the enable level and the start moment at which the amplitude light-emitting control signal is at the enable level within the third sub-frame; and
the time interval between the start moment at which the pulse width light-emitting control signal is at the enable level and the start moment at which the amplitude light-emitting control signal is at the enable level within the first sub-frame is not equal to the time interval between the start moment at which the pulse width light-emitting control signal is at the enable level and the start moment at which the amplitude light-emitting control signal is at the enable level within the second sub-frame.

7. The display panel according to claim 2, wherein
for one of the plurality of sub-pixels, one frame comprises at least three sub-frames; and
in the at least three sub-frames, the time interval between the start moment at which the pulse width light-emitting control signal is at the enable level and the start moment at which the amplitude light-emitting control signal is at the enable level gradually increases over time.

8. The display panel according to claim 2, wherein
the pulse width modulation module is configured to control the pulse width of the driving current based on a sweep driving signal and a pulse width data voltage;
within the first sub-frame, a time interval between a start moment of a linear change of the sweep driving signal and the start moment at which the amplitude light-emitting control signal is at the enable level is ta3;
within the second sub-frame, a time interval between a start moment of a linear change of the sweep driving signal and the start moment at which the amplitude light-emitting control signal is at the enable level is tb3; and
wherein ta3≠tb3.

9. The display panel according to claim 8, wherein
within the first sub-frame, a time interval between an end moment of the linear change of the sweep driving signal and an end moment at which the pulse width light-emitting control signal is at the enable level is ta4;
within the second sub-frame, a time interval between an end moment of the linear change of the sweep driving signal and an end moment at which the pulse width light-emitting control signal is at the enable level is tb4; and
wherein ta4=tb4.

10. The display panel according to claim 8, wherein
a waveform of the linear change of the sweep driving signal within the first sub-frame is the same as a waveform of the linear change of the sweep driving signal within the second sub-frame; and
a pulse width of the enable level of the pulse width light-emitting control signal within the first sub-frame is different from a pulse width of the enable level of the pulse width light-emitting control signal within the second sub-frame.

11. The display panel according to claim 8, wherein
for one of the plurality of sub-pixels, one frame comprises at least the first sub-frame, the second sub-frame, and a third sub-frame, the second sub-frame is between the first sub-frame and the third sub-frame;
the time interval between the start moment of the linear change of the sweep driving signal and a start moment at which the amplitude light-emitting control signal is at the enable level within the first sub-frame is the same as the time interval between the start moment of the linear change of the sweep driving signal and a start moment at which the amplitude light-emitting control signal is at the enable level within the third sub-frame; and
the time interval between the start moment of the linear change of the sweep driving signal and the start moment at which the amplitude light-emitting control signal is at the enable level within the first sub-frame is different from the time interval between the start moment of the linear change of the sweep driving signal and the start moment at which the amplitude light-emitting control signal is at the enable level within the second sub-frame.

12. The display panel according to claim 8, wherein
for one of the plurality of sub-pixels, one frame comprises at least three sub-frames; and
within the at least three sub-frames, the time interval between the start moment of the linear change of the sweep driving signal and the start moment at which the amplitude light-emitting control signal is at the enable level gradually increases over time.

13. The display panel according to claim 2, further comprising a driving circuit and r pixel rows;
wherein the r pixel rows comprises the plurality of sub-pixels;
the driving circuit comprises a plurality of cascaded driving units configured to output the amplitude light-emitting control signal to the pixel rows;
one of the driving units comprises a first input terminal configured to transmit a first input signal, and the first input signal is output as the amplitude light-emitting control signal during the light-emitting period under an action of a first control signal; and
within different sub-frames of one frame, widths of effective pulses of the first input signal corresponding to one pixel row is unequal.

14. The display panel according to claim 13, wherein
the driving circuit comprises m driving unit groups, one of the m driving unit groups comprises the plurality of driving units, the plurality of driving units in one driving unit group receive same first input signals, and the plurality of driving units in different driving unit groups receive different first input signals.

15. The display panel according to claim 14, wherein r is an integer multiple of m, or wherein one frame comprises n sub-frames, and r/m is an integer multiple of n.

16. The display panel according to claim 13, wherein
widths of the effective pulses of different first input signals within a same sub-frame are equal.

17. The display panel according to claim 1, wherein within the same frame, the plurality of sub-pixels does not emit light within at least one sub-frame.

18. The display panel according to claim 17, wherein
the plurality of sub-pixels operates within a first frame and a second frame, a brightness of the sub-pixels within the first frame is lower than a brightness of the plurality of sub-pixels in the second frame; and
a number of the sub-frames that do not emit light within the first frame is more than a number of the sub-frames that do not emit light within the second frame.

19. A driving method for a display panel, wherein the display panel comprises a plurality of sub-pixels,
the driving method comprising:
for one of the plurality of sub-pixels, controlling a frame to comprise at least two sub-frames,
wherein the at least two sub-frames comprises light-emitting periods during one of which a light-emitting control signal is at an enable level; and within the frame, durations of the light-emitting periods of one of the plurality of sub-pixels are different within the at least two sub-frames.

20. A display apparatus, comprising a display panel, wherein the display panel comprises a plurality of sub-pixels;
wherein, for one of the plurality of sub-pixels, a frame comprises at least two sub-frames, the at least two sub-frames comprises light-emitting periods during one of which a light-emitting control signal is at an enable level; and
within the frame, durations of the light-emitting periods of one of the plurality of sub-pixels are different within the at least two sub-frames.
